(19) United States
(12) Patent Application Publication
(10) Pub. No.: US 2024/0144324 A1
(43) Pub. Date: May 2, 2024

(54) Dynamic Relevancy in Advertising Selection

(71) Applicant: Adzerk, Inc., Durham, NC (US)

(72) Inventors: Paul deGrandis, Durham, NC (US); James Avery, Durham, NC (US)

(21) Appl. No.: 17/974,200

(22) Filed: Oct. 26, 2022

(51) Int. Cl. G06Q 30/02

(52) U.S. Cl. CPC G06Q 30/0275; G06Q 30/0257; G06Q 30/0277

(57) ABSTRACT

This document presents a system and method for improving advertising targeting through the use of a Relevancy Score for clients accessing a marketplace. The improved technology may combine advertiser information from those businesses participating in a marketplace with client request information. The improvement defines and selects ads and ad-campaigns based upon how relevant the ads or ad-campaigns selected are for the customers to be targeted to view ads from the client. The Relevancy Score may be based upon ad attributes and weights of the attributes, or may be supplied by a client to optimize the selection and presentation of ads or ad-campaigns to a client that meet or exceed a Relevancy Score prepared or provided to the system.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Digital advertising has become one of the most important revenue sources for many technology companies. Many companies utilize ad servers to monetize heavily on people's attention. Also, it may be one of the most important new businesses in the 21st century. Unlike traditional advertising techniques, digital advertising unlocks far more reliable insights about the campaign performance. Therefore, more and more advertisers start to put more budget on digital ads and more and more technology companies start to offer advertising options on their platform. Advertisers make decisions about ads to be served prior to engaging the ad platform to serve those ads.

A concern for advertisers and those who produce and serve ads is determining the relevancy of the ads to be presented to the clients. Relevancy calculations are performed in various ways, but different approaches often trade off accuracy and precision for execution speed. Relevancy is important to the targeting of ads to improve the customer experience, provide a better opportunity for engagement, and improve advertising yield for those who commission and publish ads and ad campaigns.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a flow diagram of the process for setting a dynamic relevancy score consistent with certain embodiments of the present invention.

FIG. 2 is a flow diagram of the process for setting an auto relevancy parameter consistent with certain embodiments of the present invention.

FIG. 3 is a flow diagram of the process for setting a manual relevancy parameter consistent with certain embodiments of the present invention.

FIG. 4 is a flow diagram of the process for setting a Per-ID relevancy parameter consistent with certain embodiments of the present invention.

FIG. 5 is a flow diagram of the process for disabling a relevancy score consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

When referring to a “relevancy score”, the document is referring to an ad or ad campaign-level setting that can be used to influence ad selection in an auction or lottery. An advertisement with a higher relevancy score will win an auction over similarly priced ads and the lower the relevancy score the lower the ad will be ranked in an auction.

When referring to a “relevancy request”, the document is referring to the request by a client for an ad or an ad campaign to meet a pre-established relevancy score to permit the establishment of relevancy to the client for that ad or ad campaign. This request may be added to an ad request as a relevancy request parameter.

When referring to “CPM”, the document is referring to a measure of ad impressions defined as Cost-per-mille—which is the price or value of 1000 impressions.

When referring to “eCPM”, the document is referring to the estimated or expected CPM—usually eCPM is used in place of “expected revenue” for an ad publisher.

The innovative system enables the defined processes together to influence, shape, and control what happens leading up to Selection and presentation of ads. The defined processes permit the customer to finely tune what should be a candidate for selection at request time. Doing this turns the “ad selection” process into something that looks/feels much more like “a search engine” than a traditional ad-decision engine.

The instant innovation provides an ad query system to improve the relevancy of the promoted listings and sponsored listings that will be presented to the individual initiating the search query through the processes of AdQuery, Skipfiltering, and Dynamic Relevancy.

In an embodiment, a relevancy score is an ad or ad-campaign-level setting that can be used to influence ad selection in an auction or lottery. An ad with a higher relevancy score will win an auction over similarly priced ads. In a non-limiting example, when a client has built a self-serve advertising system on top of the system herein disclosed where bidders compete in an auction, the client self-serve advertising system may take advantage of the relevancy score result provided by the system herein disclosed. Some bidders may bid a high CPM or CPC (cost per click) for impressions or clicks respectively, but their ads are not relevant to the product or service inventory, or the ads are poor quality, or the ads otherwise do not perform well. By assigning a relevancy score, the client may choose how to reward ads that are on-message and popular with viewers while requiring irrelevant ads to pay more to be eligible to serve. In an embodiment, the system as herein described may provide relevancy scores as positive integers (usually between 1 and 1 million). The lower the relevancy score, the lower the ad will be boosted in the auction.

There is a need to permit customers to take more control of ad candidate fetching/filtering and selection to ensure that the ads are more relevant to client needs and customer engagement. To meet this need, the innovative system may enable ad-hoc properties on the ad than can be searched dynamically at decision request time by the consumer. The decision request may also contain client input and criteria on calculating ad or ad campaign relevancy, including but not limited to per-attribute values, per-ad override scores, other identifiers for custom per-customer relevancy score calculations, or other metrics. Relevancy calculations may be performed dynamically during the ad filtering, selection, and presentation process. This process is referred to as Dynamic Relevancy. Dynamic Relevancy enables customers to dynamically change the weight/importance of properties on the ad, or the overall ad itself, at any point during the ad selection process.

In an embodiment, to influence the relevance of an ad or an ad campaign the innovation described herein implements a Relevancy Score that allows a customer as a user of the system to set a relevancy score on a particular ad or ad campaign and to connect and associate that customer pre-established relevancy score with the selected ad or ad campaign. It is challenging to associate a customer pre-established relevancy score with an ad or ad campaign as the customer must submit both the ad or ad campaign identifier, as an adId, and the relevancy score selected for that adId to the system at decision time for the auction or purchase of an ad or ad campaign. This is difficult to accomplish at decision time because the system would have to know the ads that would be in the candidate list at decision time.

The system processes requests for ads or ad campaigns and generates a relevancy parameter utilizing the customer input relevancy score and additional parameters. Additional parameters that may be specified at the beginning of a request may specify a number of filters for the ad or ad campaign and how those filters should be “weighted” when processing the request.

The system may create a custom relevancy based upon the customer input for the relevancy score and additional parameters that are specified at the time of the ad or ad campaign request. The system permits customers to fully control the relevancy calculation. The innovative system provides a mechanism for customers to directly use customer contextual knowledge within the scoring and ranking mechanism to assign a custom relevancy score to the eligible ads prior to selection. The contextual knowledge within the scoring and ranking mechanism may also be used to discover additional eligible ads. The scoring and ranking mechanism is completed before the discovered eligible ads are presented for selection.

The innovative system provides an extension mechanism that is performed after ad filtering but prior to ad selection that enables customers to re-evaluate all eligible ads and assign new or updated relevancy scores prior to ad selection. The extension mechanism is provided access to any additional data, model, or code that the customer has previously uploaded. The additional data, model, or code may be uploaded through one or more Application Programming Interfaces (APIs) that are provided to the customer for this purpose.

The extension mechanism has access to review and evaluate all eligible ads, and all of the properties of each ad, the current pacing information for each ad, the current eCPM (performance metric) of each ad, and any notion of relevancy that may have been previously calculated for the ad by the relevancy calculation engine of the system. The relevancy calculation engine is the set of algorithms and evaluation processes that produces the original, updated, or new relevancy score.

The extension mechanism may then return a list of ad IDs to the relevancy calculation engine with updated eCPM values. The updated eCPM values may be used to correctly bias an ad auction or lottery for one or more selected ads. The extension mechanism may fetch the “candidate ads” that could possibly be relevant for the request based upon the updated bias. Not all ads are considered, because many of them aren't relevant to the actual decision request. The extension mechanism may then filter the smaller number of candidate ads into a “final candidates” ad set. Candidate ads that might not strictly apply to the decision, or have actively been configured to be ignored may be filtered out at this point. Additionally, the list of ads returned by the extension mechanism may include ad IDs that were not originally found in the list of eligible ads initially presented.

In a non-limiting example of the calculation and use of custom relevancy, an online marketplace may frequently calculate product recommendations that are unique to each user/consumer within the marketplace. Custom relevancy enables the marketplace to upload user-product scores to the system and use those scores as a relevancy multiplier on eCPM. When a decision request is made for a given user, products represented by ads may get boosted according to the user-product scores or using a default relevancy as a pass-through gate that must be met.

In another non-limiting example, a retail media company may calculate user engagement with products or brands of products based upon click-stream data associated with those products or brands. Data science professionals working for the retail media company may produce a model that predicts engagement with the company's products. The product model created may be uploaded to the server upon which the system is operational on a periodic, regular basis. Based upon the accumulated uploaded information, the system may perform an inference for each decision request to produce an eCPM multiplier to use as a component for relevancy calculations by the relevancy calculation engine.

Additional relevancy calculations may be performed by the system to meet different requirements for relevancy conditions and requests. One such relevancy condition is auto relevancy.

Auto relevancy calculations performed by the system will use default settings for attributes, filters, and filter weightings to produce a relevancy score that provides information to a client on how relevant an ad or ad campaign is to a customer query. In an auto relevancy calculation, in non-limiting examples, a restaurant that is geographically closer to a client will rank higher than a restaurant that is located further away, an ad keyword that exactly matches a keyword in a query will rank higher than a keyword that partially matches, multiple ad query matches will rank higher than a single ad query match, or an ad with a higher event/click prediction likelihood will rank higher than an ad with a lower event/click prediction likelihood. In an embodiment, if auto relevancy is not selected and not operative only the eCPM value is used during ad selection by the system.

In an embodiment, some clients would like to tweak what parameters and conditions are more important to them from a relevancy standpoint. This type of operation provides a manual relevancy parameter that permits the client to determine what relevancy of an ad or ad query is most important to them. Manual relevancy permits the client to choose whether it is more valuable that the ad listing is geographically close to the user or that the ad listing matches better on keywords in the query. The system may use the weights manually supplied by the client, based upon which relevancy parameter basis is more important to them, to calculate the relevancy score for an ad or ad campaign.

To calculate the relevancy score using the manually input weights, the system may sum all of the weighted factors and then divide each weight by the resulting sum to normalize each input weight. The normalized weights are then applied to the default filters and attributes to create the boost multiplier for each filter and attribute. An alternative approach is to divide all weights by the max weight input, which would result in each weight being a value between 0 and 1, and then applying those weight values to each filter and attribute to create the relevancy score. In this embodiment, explicitly setting a weight to 0 will remove the contribution of that filter or attribute from the relevancy scoring calculation.

Additionally, omitting a scorable attribute will cause the system to utilize the default scores assigned within the system or within the relevancy calculation engine for that attribute. Note that all attributes that are explicitly boosted through the calculation of a manual relevancy score will be automatically boosted through the application of a pre-determined and pre-set default value for that setting.

In an embodiment, some clients have already created a relevancy score or use predictive models for their products, services, and ads. In this situation, the relevancy calculation engine may create an integration point in which to import and use this information to improve the performance of ad selection, but can also accept per-id relevancy on the ad decision request as an additional parameter. In this embodiment, dynamic relevancy calculations are performed in this predictive model through enabling per-id relevancy scoring. The per-id relevancy is able to operate on adID, flightId, or any other advertising property. To enable per-Id relevancy score calculation, the system sets the ID attribute to use and enumerates the per-Id scores within a JSON object within the ad decision request. In the embodiment, using per-Id relevancy scores will ignore the relevancy calculation engine scoring based upon ad decision criteria. The per-Id relevancy scoring also enables setting relevancy at a group level for multiple advertising properties.

In a non-limiting example, per-Id relevancy for ads and ad campaigns is the most specific relevancy criteria that may be reported. If an ad property has an ad relevancy and an ad campaign relevancy, the per-Id ad relevancy score will override the ad campaign relevancy score for that same ad property when both an ad relevancy and ad campaign relevancy are present for a single ad-unit.

In an embodiment, scorable attributes may include, but are not limited to: Distance, Keywords, Location, Site/Zone, AdQuery, EventPrediction, IdAttribute, and/or eCPM. This list is not an exhaustive list of scorable attributes and may be increased or decreased. Not all attributes or filters make sense in every calculation, as an example some attributes just do not make sense from a relevancy standpoint.

In each embodiment, relevancy can be completely disabled by not including this calculation in the client query or decision request, which will then cause the relevancy calculation engine to preserve the current behavior.

In an embodiment, the final list of ad candidates for which a relevancy score has been calculated then go through a process of “Selection,” where the ad server may operate auctions, lotteries, or other mechanisms to determine which ad should be selected as the answer for this decision request. The relevancy score is a parameter that will be used to assist in both ad selection and prediction of which ads should be selected to best represent the client request. The ad server might have to run the selection process multiple times because of certain restrictions on ads (such as, in non-limiting examples, an ad might only be allowed to be shown if it's also shown along with another ad—which is referred to as a companion ad). Additionally, the selection may be subject to client changes in the calculated relevancy score such that the selection process becomes a dynamic selection process to better represent ads and ad campaigns that are considered by the client to be more relevant to their interest, or to provide ads that the system determines are at or exceed a minimum relevancy score for client consideration.

The approaches to “Selection” are one of the critical areas of innovation within digital advertising. Historically, customers or consumers had no control over selection at ad-decision-request time as selection seemed to be a black box to the consumer. Influencing selection was only possible by manipulating the configuration of ads before the request for an ad was made.

In an embodiment, the system herein described takes the information from an ad server and merges it with the more detailed information from a client to produce an ad search query by enabling the inclusion of properties from the consumer to the search query in an ad hoc manner. The combination of advertiser information and client request information forms the basis of the ad search query and permits the system to filter these ad requests from an advertising client into the ad server's internal auction/lottery system more efficiently. In a non-limiting example, this combination yields a more efficient and more relevant result within the marketplace.

In a non-limiting example, the ad query system may improve the relevancy of the marketplace promoted listings and sponsored listings. The ad query system first provides users with the ability to add attributes in an ad hoc manner to each ad served by the marketplace through the AdQuery process. In this non-limiting example, consumers are provided with the ability to add terms such as “Brand: Honda” and “Mileage: 120,000” as attributes to each ad served by the marketplace through a consumer facing user interface. Additionally, the ad query system provides the functionality to transmit the additional search values in a structured component of the query to the ad query system decision engine. The ad query system may then restrict the ads that are eligible to be served to users based upon the updated query and the properties that have been added to update the query.

The ad query system provides the ability to serve to a user a more targeted advertisement based upon the created and updated search query. This permits the presentation of more relevant ads from the marketplace both in an initial query and as the search is refined. The creative search queries are also dynamic, incorporating additional search terms or desired characteristics from the client as the system is processing the requests. The system presents the client with the ability to input range parameters and include these parameters and other request information into the creative selection process during request formation and prior to ad selection. This amounts to customization at the ad level for consumers to be served much more targeted ads from a marketplace in a more efficient manner.

The ad query process permits passing in dynamic properties for ads to increase the targeting capability when selecting and sending ads to a consumer. Additionally, the ad query system promotes and enables the dynamic addition of property and range information to creative query requests as these attributes are presented to the end-user application (e.g., in a non-limiting example, a marketplace).

In the ad query system presented herein, the seller of an item in a marketplace is the advertiser. The seller contacts the ad query system utilized by a marketplace and selects attributes that the seller would like to attach to any ad for a particular product or service through the AdQuery process.

In an embodiment, filters may be in place that determine ads that may be selected. The Skipfiltering process permits the ad query system to dynamically select filters that are relevant to the marketplace, consumers, or both. The attributes to be added by a consumer or other user must pass through one or more filters established and managed by the marketplace and provided to each seller that would like to create and offer ads through the marketplace.

In an embodiment, attributes are curated by each marketplace that is served by the ad query system through a set of established filters, as provided in a filter template, and through the ad hoc addition of filters through the Skipfiltering process. Attributes may consist of keywords, features, or other descriptive information that contribute to the refinement of the description of a good or service. These attributes may be added, updated, or deleted dynamically by the marketplace. The marketplace controls the attributes added to an ad through a template created by the marketplace for those attributes that become desirable additions to an existing filter template. The attributes assigned through the filter template may be changed at any time by the marketplace. A seller may contact the marketplace and petition to add an attribute to a filter template that they would like to have associated with their ads. The marketplace may then add the attribute dynamically through a template update. Attributes may also be removed from a filter template by the marketplace if determined to be unused or not desirable. The attributes may be matched by the ad query server using various techniques including but not limited to exact phrase match, near-term/fuzzy-find match, and phonetic matching. The marketplace creates an attribute schema that is transmitted to sellers for their use in creating ads with attributes. The marketplace may designate different attributes for different sections of the marketplace, based upon the goods and services provided in each particular section.

In an embodiment, the ad query system may also change the weight or importance of any of the properties that are associated with an ad query from a consumer or marketplace user. If admitted by the marketplace filter as attributes that are permissible, the attribute(s) may be optimized for auto-unit-conversion (in a non-limiting example, currency or weight/mass) associated with an advertising query or request through the AdQuery process. This process of managing the weight or importance for properties is performed and managed by the Dynamic Relevancy process of the ad query system.

In an embodiment, the ad query server accepts dynamic updates to attach one or more attributes to advertising queries and requests from users through the AdQuery process. If admitted by the marketplace filter as attributes that are permissible, the attribute(s) may be added to the range parameters associated with an advertising query or request through the Skipfiltering process. The query and all associated attributes, in combination, may then be utilized by the ad query server to respond to a consumer query or request with dynamically updated, highly targeted ads presented by the marketplace and transmitted to the consumer.

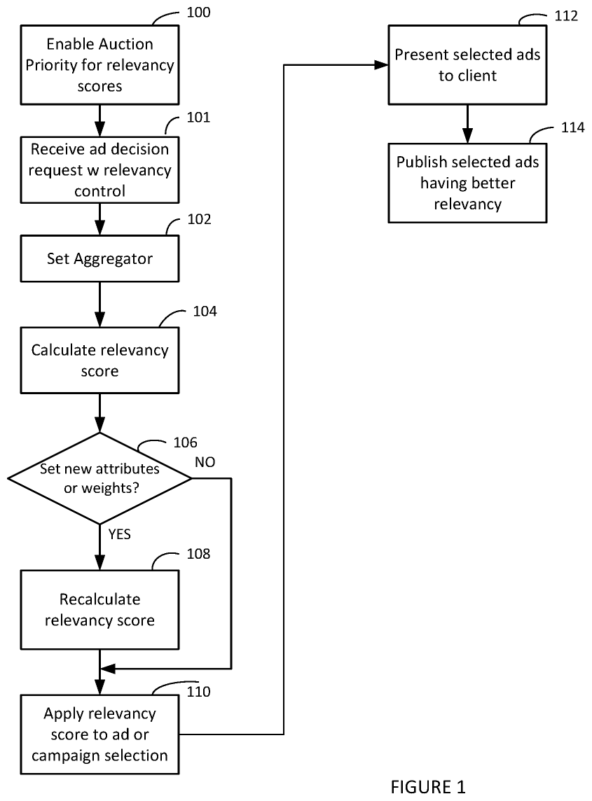

Turning now to FIG. 1, this figure presents a view of the ad query server network process for calculating a relevancy score consistent with certain embodiments of the present invention. In an exemplary embodiment, clients may contact the system to request ads or ad-campaigns that may have a higher relevancy to the types of consumers that are more likely to purchase their products and/or service in a process known as “custom relevancy”. The process begins at 100 where the client imports relevancy in the form of user-product scores. The system may import a client supplied Relevancy Score or predictive value and calculates a Relevancy Score from the predictive value. At 101, the system receives the ad decision request containing relevancy request parameter as a control parameter and initiates the relevancy calculation engine. At 102, the system initiates an aggregator to collect ads or ad-campaigns that may be relevant to the client. At 104 the relevancy calculation engine calculates the Relevancy Score and further pulls in additional eligible ads that should be considered during selection based purely on relevancy.

At 106 the system determines dynamically if there are new attributes or newly established weights for attributes that express conditions that are important to the client, based on the parameters set in the ad decision request and the user-product score. If there are new attributes or new weights for attributes, including excluding a particular attribute, the relevance calculation engine recalculates the Relevancy Score based upon the dynamically input new attributes or attribute weights at 108 and replaces the previously calculated Relevancy Score with the dynamically updated Relevancy Score. At 110 the system applies the calculated Relevancy Score to the ads or ad-campaigns previously aggregated to determine how ads or ad-campaigns will be biased during the Selection process. At 112 the system presents the ads or ad-campaigns that have been selected based upon the ad or ad-campaign meeting or exceeding the calculated Relevancy Score and presents the selected ads or ad-campaigns to the client for their review and approval.

At 114, the selected ads or ad-campaigns presented to the client are published by the client's system.

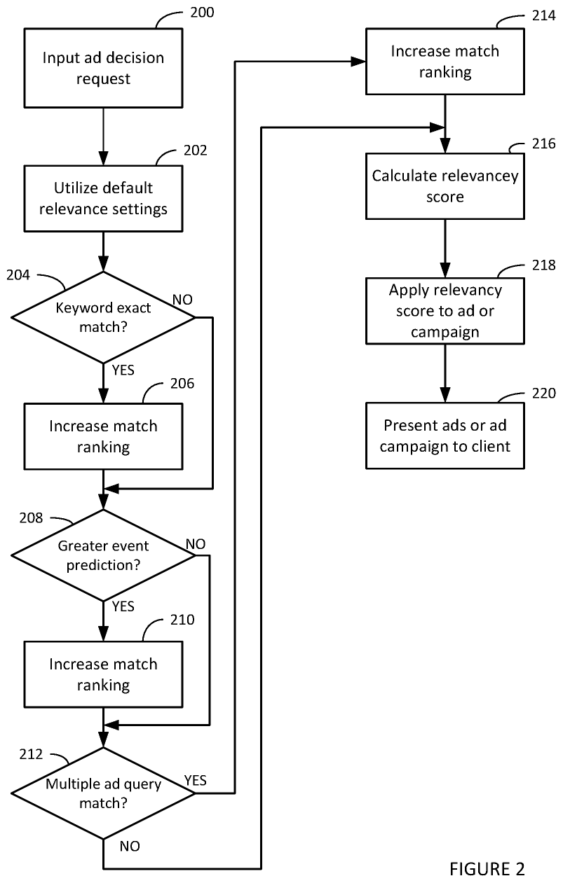

Turning now to FIG. 2, this figure presents a flow diagram of the process for setting an auto relevancy parameter consistent with certain embodiments of the present invention. In an exemplary embodiment, a client may input an ad decision request as a query to the system for ads or ad-campaigns that are relevant to the customers that the client wishes to reach through advertising at 200. At 202 the system may utilize default settings for all attributes and attribute weights when calculating a Relevancy Score by the relevance calculation engine. At 204 the system determines if an ad or an ad-campaign under consideration for selection has an exact keyword match as expressed by the client in the ad or ad-campaign. At 206, if the system determines that there is an exact keyword match in an ad or ad-campaign, the match ranking is increased and that increased value is stored for later use in the calculation of the Relevancy Score. At 208 the system determines if a greater event prediction, such as, in non-limiting examples, a higher click expectation or greater click prediction likelihood, is to be expected. At 210, if the system determines that there is a greater event prediction, the match ranking for the ad or ad-campaign is increased and that increased value is stored for later use in the calculation of the Relevancy Score. At 212 the system determines if there are multiple query matches for a particular ad or ad-campaign. At 214, if the system determines there are multiple query matches, the match ranking for the ad or ad-campaign is increased and that increased value is stored for later use in the calculation of the Relevancy Score.

At 216, incorporated all of the match value increases that have been saved by the system, the relevancy calculation engine dynamically calculates a Relevancy Score for each ad and ad-campaign that have been found to meet the elements of the client query. At 218, the dynamically calculated Relevancy Score is matched to the found ads and ad-campaigns. At 220, the ads and ad-campaigns with updated Relevancy Scores are submitted to the selection engine within the ad decision engine (in a non-limiting example, an auction). At 230, the selected ads are returned to the client, completing the ad decision request process.

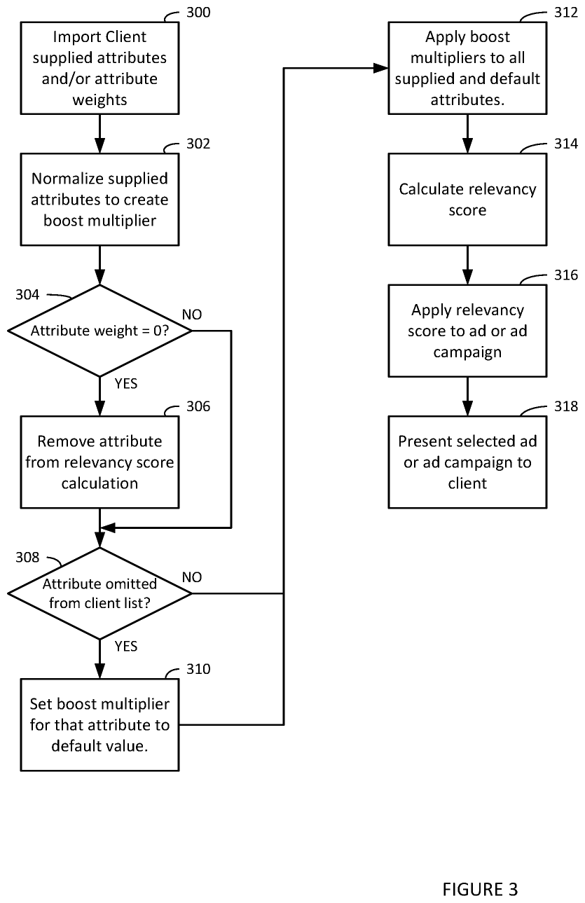

Turning now to FIG. 3, this figure presents a flow diagram of the process for setting a manual relevancy parameter consistent with certain embodiments of the present invention. In an exemplary embodiment, at 300 the client makes an ad decision request with the system, specifying the relative importance of ad targeting attributes. At 302 the sum of all supplied attribute weights is calculated and that total sum is divided by the number of supplied weights to normalize the value. This normalized weight value is used as a boost multiplier as applied to each attribute. In an alternative embodiment, each supplied attribute weight may be divided by the max weight value to produce a value for each attribute weight between 0 and 1. At 304, explicitly setting an attribute weight to 0 will remove the contribution of that weight from relevancy scoring at 306.

At 308 the system determines if an attribute is omitted from the client list. If an attribute utilized by the relevancy calculation engine is omitted from the client list, the system will set the boost multiplier for that attribute to a default value that has been previously determined by the system. At 312 the system applies boost multipliers to all supplied and default attributes to create weighted parameters for each attribute utilized in the relevancy scoring calculation. At 314, the relevancy calculation engine utilizes all weighted parameters to calculate a Relevancy Score that is in compliance with the client supplied attributes and/or attribute weights.

At 316, the system applies the Relevancy Score teach ad and ad campaign eligible for selection. At 318, the system performs the selection process (in a non-limiting example, auction or lottery). At 320, the system presents to the client all ads, and/or ad campaigns that have been selected based upon the calculated Relevancy Score.

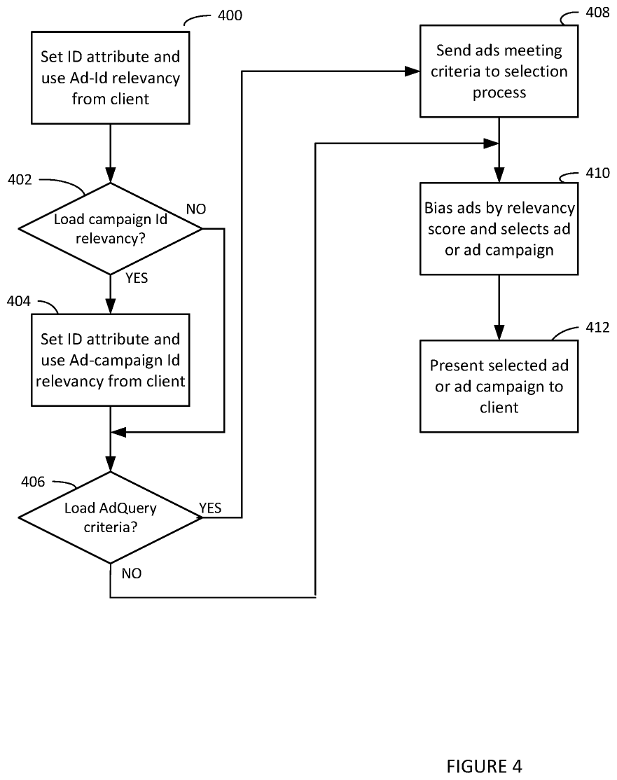

Turning now to FIG. 4, this figure presents a flow diagram of the process for setting a Per-ID relevancy parameter consistent with certain embodiments of the present invention. At 400, an ad decision request is made, specifying the use of per-id relevancy, the ID attribute to use, and listing the relevancy per ID listed. The relevancy scores are normalized by the same process as described in FIG. 3. At 402, the ad decision engine determines all eligible ads that satisfy all filtering constraints. At 404 if the ad is associated with the per-ID Relevancy parameter from the ad decision request, the ad's relevancy is set to the client supplied relevancy value.

At 406, AdQuery criteria are loaded to provide for set of ads and ad campaigns for possible selection. At 408, ads or ad campaigns are transmitted to the selection process within the ad decision engine. At 410, the ads or ad campaigns are biased by the per-ID Relevancy parameter as a Relevancy Score. Selection is performed and the winning ads or ad campaigns are presented to the client at 412.

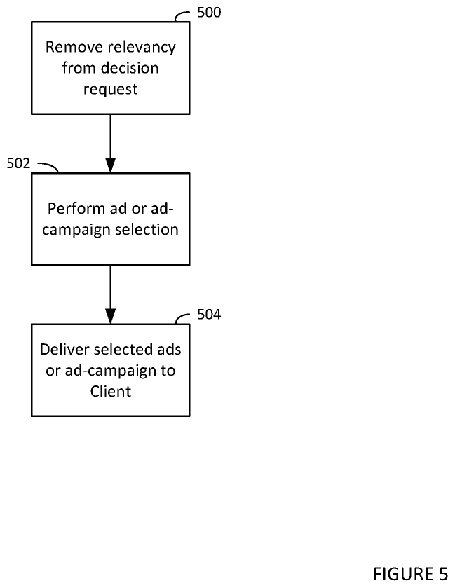

Turning now to FIG. 5, this figure presents a flow diagram of the process for disabling a relevancy score consistent with certain embodiments of the present invention. If the client has issued a request for the removal of the relevancy attribute the specified relevancy attribute is removed from the advertising decision request at 500. At 502 the relevancy calculation engine dynamically recalculates the Relevancy Score after the omission of the client supplied particular relevancy attribute. At 504, the system then presents to the client all ads and/or ad campaigns that have been selected based upon calculation for selection dynamically recalculated with the omission of the removed relevancy attribute.

While certain illustrative embodiments have been described, it is evident that many alternatives, modifications, permutations and variations will become apparent to those skilled in the art in light of the foregoing description.

1. A system for efficiently serving advertising content, comprising:
a data processor active to receive an advertising decision request from a requestor where said decision request includes a relevancy request parameter;
the data processor active to initiate an advertisement aggregator to collect one or more advertisements for relevancy evaluation;
the data processor dynamically calculating a normalized requestor advertisement relevancy score as a positive integer value requested for each advertisement or ad campaign;
the data processor dynamically calculating a normalized advertisement relevancy score as a positive integer for each advertisement or ad campaign discovered and collected by said advertisement aggregator;
the data processor comparing the normalized advertisement relevancy score for each advertisement against the requested normalized requestor advertisement relevancy score;
the advertisement aggregator retaining each advertisement that meets or exceeds the value of the normalized requestor advertisement relevancy score;
the data processor presenting each retained advertisement to the requestor;
upon selection by the requestor, the data processor publishing each selected advertisement.

2. The system of claim 1, where an advertisement further comprises an advertisement, an ad campaign, or both.

3. The system of claim 1, further comprising a requestor advertisement relevancy score to specify a number of filters for an ad or ad campaign and applying a weight value to each of said filters when processing the request advertisement relevancy score.

4. The system of claim 3, further comprising said requestor input containing per-attribute values, per-ad override scores, and other identifiers for custom per-customer relevancy score calculations.

5. The system of claim 4, further comprising adjusting said normalized requestor advertisement relevancy score by adding weights and attributes to said normalized requestor advertisement relevancy score.

6. The system of claim 1, further comprising recalculating a requestor advertisement relevancy score and re-applying the requestor advertisement relevancy score in the advertisement selection step of the process.

7. The system of claim 1, further comprising the data processor receiving an ad decision request from the requestor specifying a requestor advertisement relevancy score to apply to ad targeting attributes.

8. The system of claim 1, further comprising where selection by the ad server comprises operating any of auctions, lotteries, or other mechanisms to determine which ad should be selected as complying with the advertising request.

9. The system of claim 1, further comprising an ad query process that permits the inclusion of dynamic properties for ads to increase the targeting capability when selecting and sending ads to a requestor for advertising relevancy.

10. The system of claim 9, where the ad query system enables the dynamic addition of property and range information to satisfy advertising requests from the requestor.

11. A process for efficiently serving advertising content, comprising:
receiving an advertising decision request from a requestor where said decision request includes a relevancy request parameter;
initiating an advertisement aggregator to collect one or more advertisements for relevancy evaluation;
dynamically calculating a normalized requestor advertisement relevancy score as a positive integer value requested for each advertisement or ad campaign;
dynamically calculating a normalized advertisement relevancy score as a positive integer for each advertisement or ad campaign discovered and collected by said advertisement aggregator;
comparing the normalized advertisement relevancy score for each advertisement against the requested normalized requestor advertisement relevancy score;
the advertisement aggregator retaining each advertisement that meets or exceeds the value of the requestor advertisement relevancy score;
presenting each retained advertisement to the requestor;
upon selection by the requestor, publishing each selected advertisement.

12. The process of claim 11, where an advertisement further comprises an advertisement, an ad campaign, or both.

13. The process of claim 11, further comprising a requestor advertisement relevancy score to specify a number of filters for an ad or ad campaign and applying a weight value to each of said filters when processing the request advertisement relevancy score.

14. The process of claim 13, further comprising said requestor input containing per-attribute values, per-ad override scores, and other identifiers for custom per-customer relevancy score calculations.

15. The process of claim 14, further comprising adjusting said normalized requestor advertisement relevancy score by adding weights and attributes to said normalized requestor advertisement relevancy score.

16. The process of claim 11, further comprising recalculating a requestor advertisement relevancy score and re-applying the requestor advertisement relevancy score in the advertisement selection step of the process.

17. The process of claim 11, further comprising the data processor receiving an ad decision request from the requestor specifying a requestor advertisement relevancy score to apply to ad targeting attributes.

18. The process of claim 11, further comprising where selection by the ad server comprises operating any of auctions, lotteries, or other mechanisms to determine which ad should be selected as complying with the advertising request.

19. The process of claim 11, further comprising an ad query process that permits the inclusion of dynamic properties for ads to increase the targeting capability when selecting and sending ads to a requestor for advertising relevancy.

20. The process of claim 19, where the ad query system enables the dynamic addition of property and range information to satisfy advertising requests from the requestor.
